(19) United States
(12) Patent Application Publication
(10) Pub. No.: US 2016/0335564 A1
(43) Pub. Date: Nov. 17, 2016

(54) SYSTEMS AND METHOD FOR DELIVERING AND PROCESSING ELECTRONIC TICKETS VIA ELECTRONIC PLATFORM

(71) Applicant: Picd.us, Inc., Nashville, TN (US)

(72) Inventors: Timothy Downy, Nashville, TN (US); Van Simmons, Nashville, TN (US); Geoffrey Gross, Nashville, TN (US)

(21) Appl. No.: 15/067,927

(22) Filed: Mar. 11, 2016

Related U.S. Application Data
(60) Provisional application No. 62/132,207, filed on Mar. 12, 2015.

(51) Int. Cl. G06Q 10/02; H04W 4/00; H04L 29/08

(52) U.S. Cl. CPC G06Q 10/02; H04L 67/02; H04W 4/008

(57) ABSTRACT

A system comprises under one embodiment one or more applications running on at least one processor of at least one remote server, an attendant application running on at least one processor of an attendant device and a user application running on a processor of a mobile device. The system includes the one or more applications generating an event and an electronic ticket associated with the event. The system includes the one or more applications pushing the electronic ticket to the mobile device. The system includes the mobile device approaching the attendant device in proximity to an event and communicating the electronic ticket to the attendant device. The system includes the attendant device validating and canceling the ticket.

### CROSS REFERENCE TO RELATED APPLICATIONS

This application claims the benefit of U.S. Application No. 62/132,207, filed Mar. 12, 2015.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BRIEF DESCRIPTION OF THE DRAWINGS

FIG. 1 shows the interaction between components of the Tealpass platform under an embodiment.

FIG. 2 shows a login page for the Tealpass platform, under an embodiment.

FIG. 3 shows a My Events page of the Tealpass application, under an embodiment.

FIG. 4 shows a My Events page of the Tealpass application, under an embodiment.

FIG. 5 shows a My Events page of the Tealpass application, under an embodiment.

FIG. 6 shows the Tealpass platform implemented within a university systems architecture, under an embodiment.

FIG. 7 shows a Data Dashboard of the Tealpass platform, under an embodiment.

FIG. 8 shows a facility map screen, under an embodiment.

FIG. 9 shows a facility map screen, under an embodiment.

FIG. 10 shows a facility map screen, under an embodiment.

FIG. 11 shows a facility map screen, under an embodiment.

FIG. 12 shows a facility map screen, under an embodiment.

FIG. 13 shows a facility map screen, under an embodiment.

FIG. 14 shows an electronic student id card, under an embodiment.

FIG. 15 shows an electronic student id card, under an embodiment.

FIG. 16 shows an electronic student id card, under an embodiment.

FIG. 17 shows an electronic student id card, under an embodiment.

FIG. 18 shows an electronic student id card, under an embodiment.

FIG. 19 shows a method for creating an event using the Tealpass platform, under an embodiment.

FIG. 20 shows a system for creating and delivery electronic tickets, under an embodiment.

So that the manner in which the systems and methods described herein for delivering tickets via electronic platform can be better understood, certain illustrations, charts and/or flow charts are appended hereto. It is to be noted, however, that the drawings illustrate only selected embodiments of the systems and methods described herein and are therefore not to be considered limiting of scope, for the systems and methods described herein may admit to other equally effective embodiments and applications.

### DETAILED DESCRIPTION OF CERTAIN EMBODIMENTS

Systems and methods for delivering electronic tickets via electronic platform are herein described using the following sections.
Tealpass Functionality Overview Explanation From the BackendViewpoint.
Tealpass Functionality Overview with Second Explanation From the Backend Viewpoint.
Tealpass Functionality Overview with Second Explanation From the Backend Viewpoint
Tealpass Music Industry Use Process.
Tealpass Healthcare Use Process,
Tealpass Transportation Use Process.
iBeacon Launching an Application In A Persons Pocket
BLE Attendance Checking
BLE Large Scale attendance
BLE Digital Student/BLE Digital ID

For purposes of the following discussion the term Tealpass platform includes under one embodiment the Tealpass application (running on user/attendee device), the TealpassGate application (running on user/attendant device) and Tealpass backend, the Tealpass backend application, Tealpass server, or Tealpass server application (each comprising at least one application running on one or more servers communicatively coupled to both attendant and attendee devices). The term Tealpass platform may refer to one or more of the Tealpass application, the TealpassGate application, the Tealpass backend, the Tealpass backend application, Tealpass server, or Tealpass server application and any associated devices/servers/applications. The meaning Tealpass platform in governed by the context of its use.

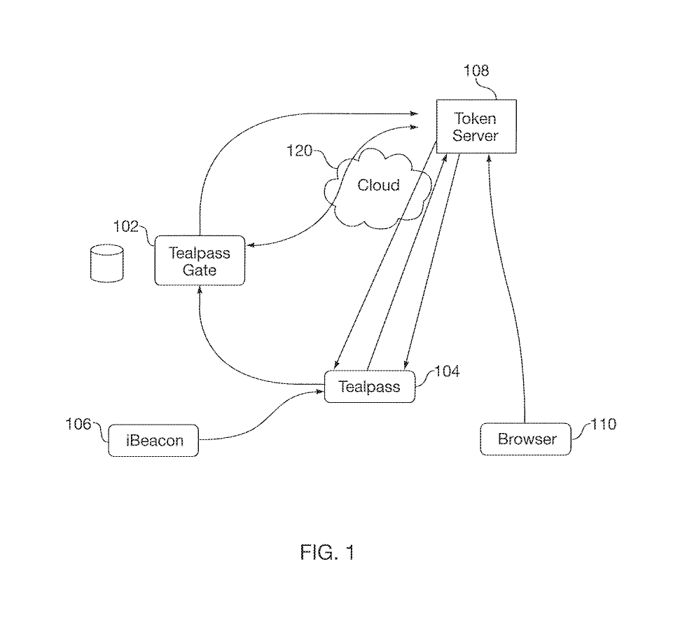

FIG. 1 shows a TealpassGate application 102 which runs on the processor of an attendant computing device under an embodiment. FIG. 1 shows a Tealpass application 104 which runs on the processor of an attendee mobile computing device under an embodiment. FIG. 1 shows an iBeacon 106 in physical proximity to the attendant computing device and the event or venue (as further described below) under an embodiment. FIG. 1 also shows the Tealpass backend “Token” servers 108. One or more applications run on at least one processor of such servers to provide Tealpass platform functionality. FIG. 1 also shows a web browser 110 communicatively coupled with the Token servers. Note that all components of FIG. 1 are communicatively coupled with each other (through general internet/cloud connectivity 120) and function in a manner as described below.

Tealpass Functionality Overview with Explanation from the Backend Viewpoint

The Tealpass platform may automatically download passes to events purchased by attendant on the Tealpass website to an attendee's smartphone.
Tickets are under an embodiment in the form of unique keys which are associated with registered UDID's (Unique Device IDentifier) of the attendee on the Tealpass server application. The UDID is generated on a user's device, using standard functionality of the operating system and is passed to the back end system when the user logs in using that device. The backend stores all of the UDIDs received from devices used by the user.
Tickets are under an embodiment good only for a specific period of time.
Tickets are under an embodiment revocable by the issuer, i.e. vendor or user/attendant using the Tealpass platform to issue, monitor, track, and/or redeem electronic tickets.

The Tealpass application automatically presents a pass to an event. Presenting a pass involves the attendant's Tealpass application advertising the availability of the pass as a Bluetooth LE service. The decision to advertise a ticket or pass for detection may occur under the following conditions:
The user's/attendant's smartphone, i.e. Tealpass application, detects the presence of a Bluetooth ‘beacon’ associated with an event venue, under an embodiment.
The Tealpass application notes the current time and confirms that the moment of advertising is within an appropriate time window for that attendee's pass at that event, under an embodiment.
The mechanism under one embodiment is that there is a beacon associated with the venue, which causes attendee's Tealpass application to launch into background of attendee's smartphone and advertise a service associated specifically with the event. The “launch into background on region entry” is standard functionality on iOS and Android smartphones. Regions may be specified as GPS-defined polygons or by proximity to a Bluetooth “beacon” (e.g. an Apple iBeacon). The differentiating factor here is that, on launch, the Tealpass platform uses the identity of the beacon to determine which ticket to advertise via a Tealpass Bluetooth service which is a novel use of the standard OS functionality.

When Tealpass application advertises ticket availability, a TealpassGate attendant running the TealpassGate application on a smartphone will detect the advertisement of the ticket. The TealpassGate application may connect and authenticate with the attendee's smartphone over Bluetooth LE. The attendant (or TealpassGate application) then ‘asks’ for a cryptographically secured ticket token. Note that ticket token information includes associated beacon identification information, under an embodiment.

The TealpassGate application then validates the ticket token as being . . .
a valid ticket;
issuing as a service from a device which is a valid UDID for the ticket.

The TealpassGate application then performs under an embodiment hands free validation and cancellation of tickets in a cryptographically secure manner. When the TealpassGate accepts a ticket it simultaneously records the unique id of the ticket in a shared database on backend servers and validates and cancels the ticket in the backend database. The backend database then pushes the ticket cancellation to all of a user's devices. The ticket cancelation is then displayed on the UI of each mobile device. All of this happens without either the attendee or TealpassGate attendant being required to touch the attendee device.

Second Explanation from the Backend Viewpoint

A TealpassGate application interacts with attendee Tealpass application as follows under an embodiment.
This example includes at least 2 smartphones, an iBeacon, and a laptop (and maybe an AppleTV) which is hooked up to a monitor. Internet access is required for all hardware (except the iBeacon). This configuration may require a WiFi hotspot for reliability in using the Apple TV and the laptop.
Attendant logs in as a “TealpassGate” using TealpassGate application on one smartphone. The second smartphone functions as an attendee, i.e. the second smartphone runs the Tealpass application.
The smartphone device running the Tealpass application is initially in sleep mode.
Using the TealpassGate application, attendant picks a venue from the predefined list on the application's main page. This venue is under an embodiment tied to an iBeacon as described above.
TealpassGate shows that there are no events for the selected venue.
Attendant creates a new event which happens currently in real time; attendant creates the event by using the laptop to access a create Event API provided by TealpassGate application. Attendant (a) ensures that the created event is for “right now” so that the TealpassGate application may begin accepting tickets “right now” and (b) ensures that the created event is for the venue associated with the iBeacon so that attendee's Tealpass application is stimulated into broadcasting its ticket when in proximity of the iBeacon.
Attendant uses the TealpassGate application to observe the appearance of the new event that was just created.
Attendant starts “taking tickets” via the TealpassGate application.
Without ever bringing the Tealpass attendee smartphone out of sleep mode, attendee waves attendee smartphone in front of the TealpassGate smartphone/device. Nothing happens—no deny, no admit, no nothing. This is because Tealpass is not yet active due to the fact that there is no ticket available for the new event.
Attendee may buy a pass for a new event via the Tealpass platform website. A Tealpass ticket creation API causes a push notification to be sent to attendee's smartphone, which is in sleep mode under an embodiment. The Tealpass application may then download the ticket. The Tealpass application running on attendee's smartphone should quickly announce that it has received a new ticket via audio, visual, or tactile prompt if the Tealpass application is running in background.
Without ever bringing the Tealpass smartphone out of sleep mode, attendee may wave it in front of a TealpassGate smartphone.
The Tealpass application and TealpassGate application establish a communication session, and the TealpassGate application receives a cryptographically secure ticket token. (Observe the “ADMIT” display on TealpassGate smartphone indicating detection of valid ticket).
The TealpassGate application validates ticket and communicates use of the ticket with Tealpass platform servers which maintain data on ticket usage.
Attendee may bring the Tealpass application out of sleep and observe that the ticket has now been used.
Under an embodiment, the Tealpass application may be awake during advertising of the ticket so that the ticket may be seen by attendee during such process.

One or more applications and/or Tealpass APIs running on one or more Tealpass servers interact with a web based User Interface, Tealpass application, and TealpassGate to perform the following tasks/functionalities under an embodiment:

Ticket Creation—a “create Ticket” API provides the following functionality under an embodiment.
Push notification of a new ticket being created for an attendee to all devices where that attendee is logged into Tealpass application.
Push notification of a new ticket being created for an event to all devices where a TealpassGate is logged in and collecting tickets for that event
Ticket Cancellation—Push notification of a ticket being cancelled by a gatekeeper to all devices where a TealpassGate is logged in and collecting tickets for that event and to all devices registered to the attendee.
Accept ticket UDID.
Validate attendant/user as a valid TealpassGate for the event associated with the ticket ID included in the ticket token (generated by Tealpass platform and associated with UDID).
Mark ticket as cancelled in Tealpass database maintained on one more Tealpass servers.
Send push of ticket being cancelled for an event to all devices where the attendee for that ticket is logged in.
Send push of ticket being cancelled for an event to all devices where a TealpassGate is logged in and collecting tickets for that event.

Add new UDID—an “add new UDID” API provides the following functionality under an embodiment.
Accept UDID for a device. A device UDID is generated via cryptographically secure mechanism on the device and passed at login to the Tealpass backend. Passes may be redeemed only on the condition that the device presenting the ticket has been previously registered as being a device associated with the purchaser's account (i.e. purchaser had to log into Tealpass backend server application at least once with that device).
Add/associate that UDID to/with all outstanding tickets for that user. This is to allow multiple devices to redeem pass. The redeeming device must be one of the devices in the list of devices registered to the purchaser of the pass under an embodiment.

Create new event—a “create new Event” API provides the following functionality under an embodiment.
Accept Event Name, Venue Name, event From/To date, allow entry From/To date.
Validate that venue exists.

Validate that attendant/user is logged in as an valid event manager and use that attendant/user id. (Note that TealpassGate users register with Tealpass backend using the TealpassGate application).

Create event based on other provided parameters.

Tealpass Functionality Overview with Second Explanation from the Backend Viewpoint

A Tealpass application running on user's personal computer, tablet, smartphone or mobile computing device in conjunction with Tealpass platform servers provides the following services.

1. Attendee/user registers or signs up for the service using a web based client application.

2. Attendee/user registers a mobile device uniquely (as a UDID) with the Tealpass backend servers, associating the device with a particular user's account.

3. Upon

a) coming out of background or

b) at launch or

c) with specified periodicity or

d) at receipt of a push notification, the Tealpass application downloads any new ticket tokens from the Tealpass backend servers.

The Tealpass application should be badged for any undownloaded tickets whenever a push notification is received. If there are tickets to download, the Tealpass application should be “badged” with the number of tickets to download.

4. Download iBeacon UMMs associated with an event from the backend system whenever a token is downloaded. UMM (UUID/Major/Minor) is the unique identifier of an Apple iBeacon. When you purchase a pass, the downloaded information about the pass contains the event for which the pass was purchased. The event includes a venue. The venue includes a set of UMM's. Multiple UMMs may correspond to a single venue, under an embodiment. The application will use the UMM of a venue to determine which pass to advertise.

5. Attendee's/user's Tealpass application ranges for beacons associated with an upcoming event and launches into background upon detection of an appropriate beacon. Note that the beacon periodically transmits its UMM. The Tealpass application then detects the UMM. The Tealpass application may then use the UMM to identify the appropriate ticket token for an event associated with a venue.

6. Attendee's/user's Tealpass application advertises over Bluetooth Low Energy (BLE) a service, which provides the ticket token for the current event and the device UDID as BLE characteristics of the service.

7. The TealpassGate application securely connects to the attendee device BLE service and obtains a specific ticket token and device UDID issued with respect iBeacons, i.e. set of MMUs, associated with a venue.

8. The TealpassGate application validates and “cancels” the ticket so that it cannot be used again and reports information to Tealpass backend servers. (Note that the TealpassGate application may download information from Tealpass backend servers for local validation. Alternatively, the TealpassGate application may communicate with Tealpass backend servers in validating tickets).

9. Attendee's/user's Tealpass device makes a sound (or issues a visual or tactile alert) when connected to by a TealpassGate application to alert the user that the user's ticket has been scanned and cancelled.

A TealpassGate application running on attendant's computing device (including personal computers, tablet, smartphone or mobile computing device) in conjunction with Tealpass backend servers and applications running thereon provides the following services.

1. The TealpassGate application launches on a smartphone device and scans for advertising by attendant device applications.

2. Upon detection of an attendee Tealpass application which meets a high threshold RSSI (received signal strength indicator), TealpassGate application connects to the attendee application and gathers the Ticket token and the UDID of the device.

3. Upon gathering a ticket token from the device, the TealpassGate verifies the validity of the ticket/UDID pair and audibly and visibly alert the TealpassGate attendant/user as to whether the ticket/UDID pair is valid or invalid. If invalid the TealpassGate application provides an explanatory indication (Wrong event, wrong UDID, wrong key, etc.).

4. The Tealpass platform updates the ticket token status on backend servers to indicate whether or not the ticket token has been used.

Tealpass Music Industry Use Process

Tealpass may be used in any level of venue or event. Under an embodiment, the Tealpass application can be used to enable events to replace ticket scanners or any type of ticketing mechanism, with the Tealpass platform.

The way that it works is when a person buys a ticket to an event one of two things occurs under an embodiment:

1. Under one embodiment, a screen that says download, print, text, or email your ticket may be replaced by a prompt saying download Tealpass application. This prompt may also appear next to the prompts of download, print, text, email, etc. In other words, Tealpass at an event means that the ticket transfer is done through downloading the Tealpass application. Usually event ticket purchase and transfer applications display “Download, print, text, or email your ticket” after you make the purchase. Tealpass can enable all of that to be replaced with “Download Tealpass”, or the “Download Tealpass” can be included next to the “Download, print, text, or email your ticket”.

Under an embodiment, Tealpass can be white labeled so that the Tealpass technology is incorporated with the existing platform or application that is used by the ticket provider (i.e., the ticket provider from which the attendee/user buys the ticket). This means that Tealpass' technology would be used without any of Tealpass branding.

Under an alternative embodiment, if Tealpass is not white labeled, then the individual (attendee/user) buying the ticket is prompted to download the Tealpass application. In this case, the attendee's ticket is located within the Tealpass application itself with full Tealpass branding.

At the event itself, there is under one embodiment a person holding a device with the TealpassGate application opened; each attendee pulls out their respective smartphone/device and opens the Tealpass application, which then communicates with the TealpassGate application in the manner described above. The TealpassGate application communicates to the attendant at the entrance either an admittance screen or denial screen; the attendee is either allowed in or not allowed in accordingly.

2. Under an alternative embodiment, every bit of functionality stays the same except for the part about a person physically holding the opened TealpassGate application. In this scenario there is a piece of hardware (comprising computing resources sufficient to run TealpassGate) such as a turnstile with the TealpassGate installed in it. Under this embodiment, the TealpassGate application operates the turnstile to admit or deny admittance as needed. The TealpassGate application may integrate with and control operation of any such threshold device. In each scenario the TealpassGate application determines if a person can walk in or not when an attendee with the Tealpass application approaches. Such gatekeeping devices (coupled with TealpassGate functionality) may include . . .
A lock programmed with the TealpassGate technology to lock/unlock accordingly.
A turnstile programmed with the TealpassGate technology to lock/unlock accordingly
A screen programmed with the TealpassGate technology tells the attendee to enter or not enter accordingly.
A voice technology programmed with the TealpassGate technology verbally tells the attendee to enter or not enter accordingly.

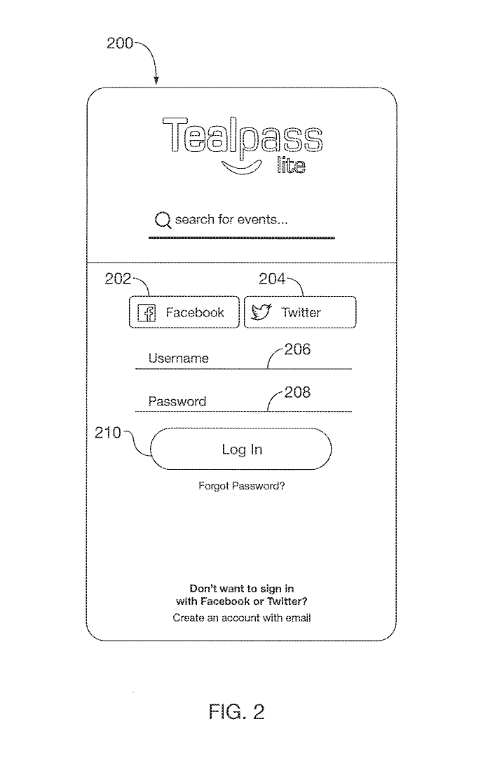

FIG. 2 shows a login page 200 for the Tealpass platform. The login page allow login 210 using Facebook™ 202 or Twitter™ 204. The login page solicits username 206 and password 208.

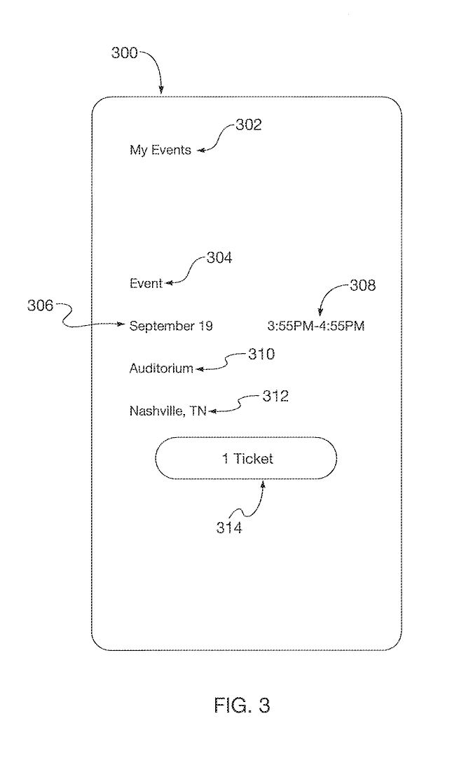

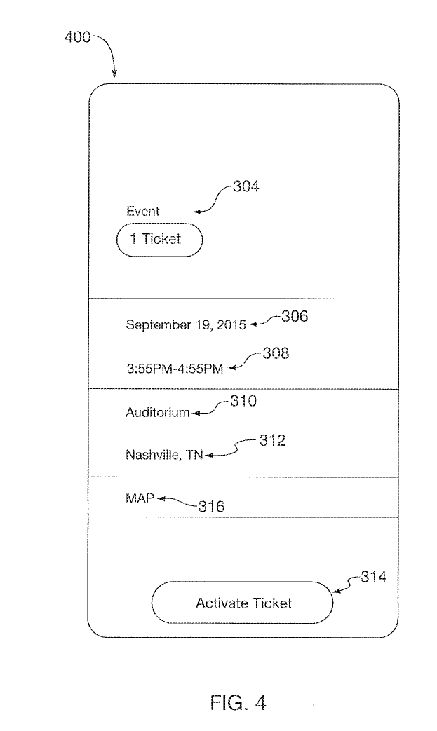

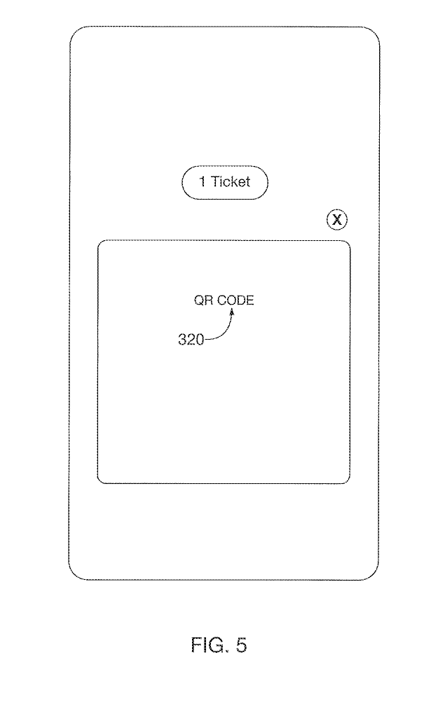

FIG. 3 shows a My Events page 300. The page features a My Events banner 302 at the top of the page. The page shows the date 306 and time 308 of the event. The event 304 will take place at auditorium 310 in Nashville, Tenn. 312. The page features a ticket button 314. The attendee pushes the button to proceed to the ticket page 400 as seen in FIG. 4. The ticket page also shows the date 306 and time 308 of the event. The ticket page also shows that the event 304 will take place at auditorium 310 in Nashville, Tenn. 312. The ticket page also displays a map 316 showing the exact location of the event. The ticket page provides user with an activate ticket button 314. The activate ticket button triggers BLE advertising via the Tealpass application running on the smartphone. The active ticket button also causes the Tealpass application to generate and display a QR code 320 (as seen in FIG. 5) which may be used as a ticket with conventional QR code readers.

Tealpass Healthcare Use Process

Tealpass was designed and engineered with the individual in mind to ensure security, ease of use, and quality of each encounter.

The global reach of Tealpass allows data and equipment to be securely interchanged in an enjoyable manner with less effort. The unique individualized gatekeeping technology of Tealpass provides consumers with a streamlined process fostering patient confidence and satisfaction throughout their medical encounters.

This process is easily accomplished under one embodiment using two smart devices, such as a smartphone and tablet, to create a secure interaction between the Tealpass user application and the TealpassGate.

Under an embodiment, Tealpass technology focuses on doctor-patient confidentiality by individualizing access to medical information between the patient and healthcare personnel. The patient may simply register through a Tealpass secure application using a smart device which minimizes wait time, alerts the appropriate staff upon patient arrival, initiates interaction with their scheduled ancillary devices, and alerts the healthcare personnel of the patient's status; thereby maximizing productivity and minimizing down time for the patient and staff. Tealpass' gatekeeping method allows only specified staff, such as nurses and physicians, to access designated equipment and information, such as a dialysis machine designated for a given patient. Tealpass allows under this embodiment for selective access throughout all aspects of the patient encounter, thereby expediting the process, improving the overall quality of care and patient satisfaction from check in to discharge, including secure registration, transfer of records, specifying staff, equipment access, and staff notification.

The Tealpass technology is white labeled to enhance confidence and brand recognition by ensuring that the practice or medical facility is the only trusted brand the patient and staff see.

### Examples

An individual preparing to visit the Emergency Room may under an embodiment utilize Tealpass to get in faster. Before preparing to enter the facility, the patient checks in on a Tealpass enabled application, thereby enables the patient to immediately be checked in upon entering the Emergency Room. The corresponding TealpassGate enabled application or hardware, is installed at the front of the Emergency Room in order to communicate with the patient checking in upon walking through the door.

A piece of medical equipment such as a dialysis machine or any other device may have the TealpassGate application installed inside of it. In order to unlock the machine, a corresponding Tealpass application must be near which is likely held by a specific doctor.

A TealpassGate application may be installed inside of doors within the hospital. In order to have clearance to walk through certain doors, doctors, nurses, or patients must have the corresponding Tealpass application to “unlock” Tealpass monitored thresholds.

Tealpass Transportation Use Process

Tealpass for transportation is meant to speed up the boarding process for airplanes, busses, trains, subways and even taxis. In fact, Tealpass may under an embodiment fit into any scenario that includes authentication between two devices. Tealpass is a new type of secure easy check in system. TealpassGate may be incorporated with existing hardware, so airlines and other transportation companies may streamline the boarding process even more. Tealpass can help improve the customer experience and manage growth. Tealpass can be customized and can work inside existing applications and systems making it seamless for the user.

### Examples

In the case of a bus, plane, train, subway, or any other mass transit system, each rider is prompted under an embodiment to download the Tealpass application (or Tealpass is white labeled as part of the carrier's own application). The bus driver may have any mobile device (like a smartphone or tablet) with the TealpassGate application opened. To get on the bus, the customer waves his device near the driver's device. Under an alternative embodiment, a premium Tealpass application is available where the rider does not even have to take the device out of his or her pocket or purse to interact with the gate. The application launches automatically in the riders pocket, and signals the driver's device to go “green”.

In the case of installed car services such as Apple CarPlay, Tealpass may be installed as an application on the user interface. Whenever the driver leaves a paid parking lot with TealpassGate installed in the payment station, the driver can pay with a touch of a button on the Tealpass application installed in the car. In this scenario, TealpassGate can also be installed in personal garage doors and gates; the Tealpass application is used to unlock either at the touch of a button.

iBeacon Launching an Application in a Persons Pocket

Tealpass may under an embodiment launch an application inside of a person's pocket by using an iBeacon. This has been referred to multiple times within this application; however, it is an additional add on to streamline the process of the Tealpass system.

The way it works, is whenever a person is in range of the iBeacon, the iBeacon communicates with the Bluetooth enabled device and launches a specific application in the persons pocket. All without the person having to touch the smartphone at all.

BLE Digital Student ID/BLE Digital ID

The systems and methods described herein may be used to replace any instance of a traditional ID card. Under an embodiment, the Tealpass application running on persons smartphone may function as the person's ID card for gaining access to places of interest.

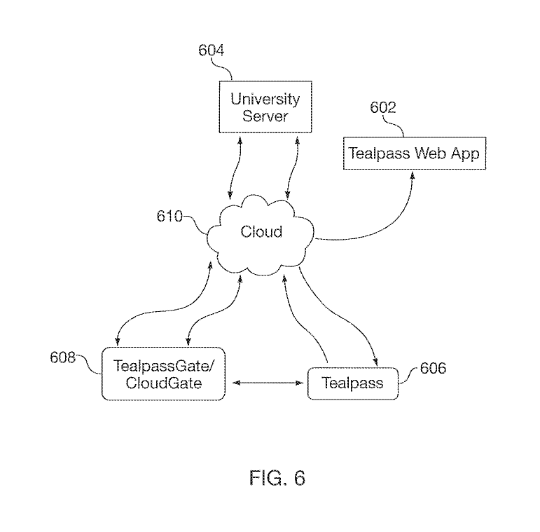

FIG. 6 shows the Tealpass platform implemented within a university systems architecture. A student may use a Tealpass web application 602 to register with the university server 604 (running one or more applications for managing the Tealpass platform). The student also logs into the university server using a Tealpass application 606 running on a smartphone device. This process provides the university server with the smartphone's UDID which is then associated with the student's registration profile. The university server may issue the student with a student ID in the form of a Tealpass ticket token. When a student approaches a facility, the Tealpass application may detect the broadcasting signal of a CloudGate 608 (which functions like a TealpassGate as described above). The Tealpass application 606 then passes the student ID to the CloudGate which then determines whether the token is valid. In other words, the CloudGate determines if the ID is associated with access privileges regarding the given facility. The CloudGate validates or denies the student ID and passes this information back to the Tealpass application and the university server. The Tealpass application ceases advertising a BLE service. In this manner the Tealpass platform may control access to facilities. Alternatively, the Tealpass platform may simply track the location of the student as the student roams among and within university facilities. Component of the Tealpass platform implemented within a university systems architecture shown in FIG. 6 are communicatively coupled through general internet/cloud connectivity 610.

Under one embodiment, a student ID card is used to track certain student activity, e.g. present for class, checking into dorm rooms, unlocking dorm rooms, entering/exiting facilities, checking out/library books, purchases at food vendors, convocation/chapel attendance, etc. The Tealpass application running on persons smartphone may function as the student's ID card for tracking such activities.

Under one embodiment, management of any facility traditionally requires key fobs/ID cards to open doors, check in at front desk, etc. The Tealpass application running on a person's smartphone may function as the ID card required for use of managed facilities.

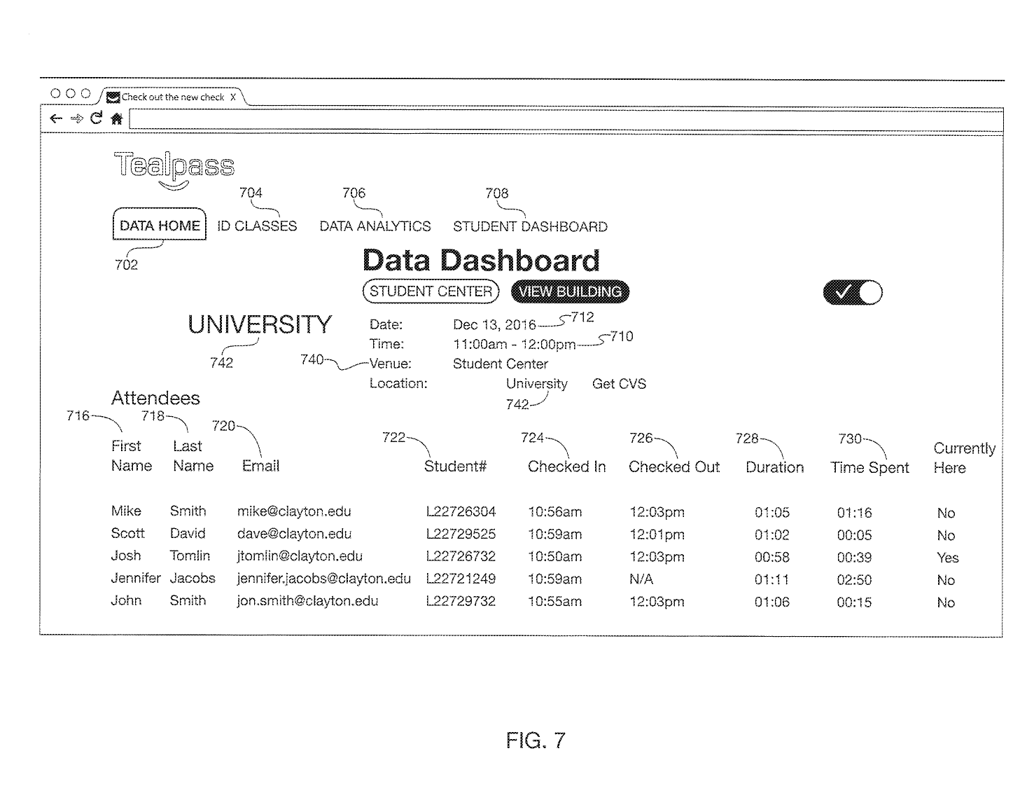

FIG. 7 shows a Data Dashboard for university 742. The Data Dashboard shows a data home tab 702, ID classes tab 704, data analytics tab 706 and a student dashboard tab 708. FIG. 7 shows the Data Dashboard with data home tab 702 selected. The Data Dashboard provides location information for student attendees regarding a student center venue 740 on a particular date 712 and time 710. The information includes first name 716, last name 718, email address 720, student id 722, time checked into student center 724, time checked out from student center 726, duration of stay 728, time spent 730, and currently here (yes/no) status 732.

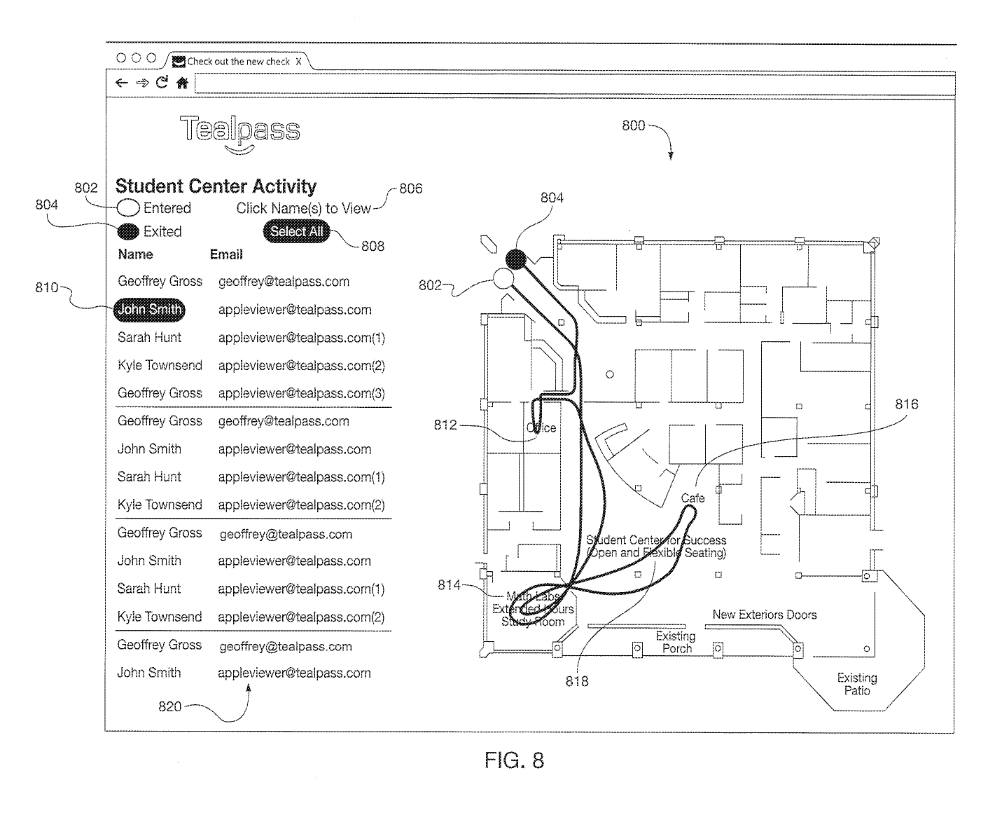

FIG. 8 shows an academic facility map screen 800 showing the location of a student entering and roaming about the academic facility 800. The top left of FIG. 8 shows a legend featuring a clear circle 802 and a solid circle 804. The clear circle indicates facility entry point while the clear circle indicated facility exit point. The left column of FIG. 4 lists student names and email addresses 820. A user may click names 806 to view student location data or may select all 808 students. FIG. 8 shows that the user has selected John Smith 810. The facility map screen 800 shows John Smith's entry 802 and exit 804 locations. The facility map screen 800 also shows John Smith's real time movements in the facility. Under one embodiment, the Tealpass platform computes John Smith's real time location using triangulation among BLE access points, TealpassGates or CloudGates. FIG. 8 indicates that John Smith has visited office 812, Math Lab 814, Student Center Open Seating 818 and café 816.

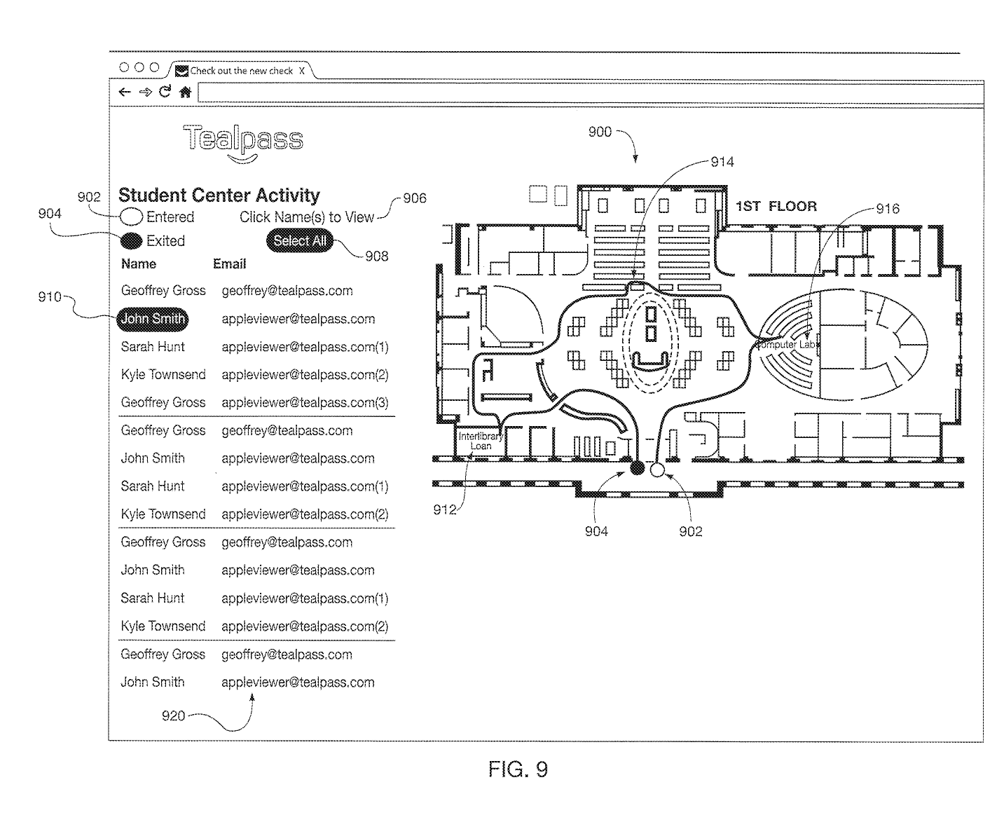

FIG. 9 shows an academic facility map screen 900 showing the location of a student entering and roaming about the academic facility 900. The top left of FIG. 9 shows a legend featuring a clear circle 902 and a solid circle 904. The clear circle indicates facility entry point while the clear circle indicated facility exit point. The left column of FIG. 9 lists student names and email addresses 920. A user may click names 906 to view student location data or may select all 908 students. FIG. 9 shows that the user has selected John Smith 910. The facility map screen 900 shows John Smith's entry 902 and exit 904 locations. The facility map screen 900 also shows John Smith's real time movements in the facility. Under one embodiment, the Tealpass platform computes John Smith's real time location using triangulation among BLE access points, TealpassGates or CloudGates. FIG. 9 indicates that John Smith has visited the interlibrary loan office 912, reference section 914, and computer lab 916.

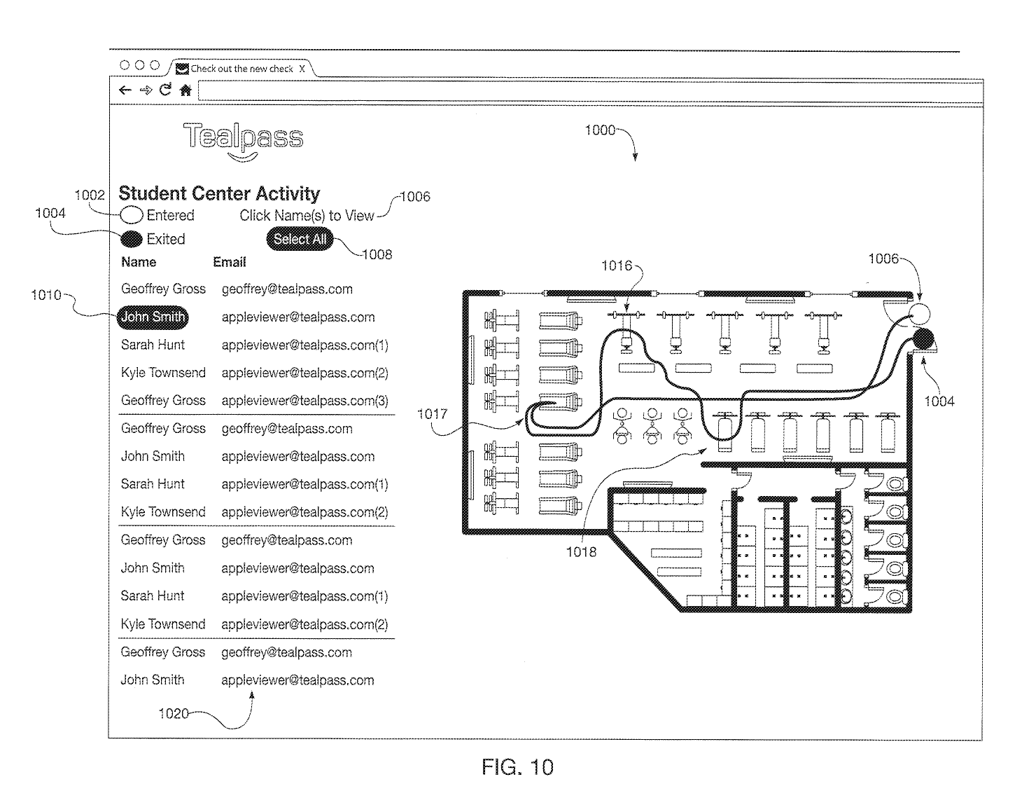

FIG. 10 shows an athletic facility map screen 1000 showing the location of a student entering and roaming about the athletic facility 1000. The top left of FIG. 10 shows a legend featuring a clear circle 1002 and a solid circle 1004. The clear circle indicates facility entry point while the clear circle indicated facility exit point. The left column of FIG. 9 lists student names and email addresses 1020. A user may click names 1006 to view student location data or may select all 1008 students. FIG. 10 shows that the user has selected John Smith 1010. The facility map screen 1000 shows John Smith's entry 1002 and exit 1004 locations. The facility map screen 1000 also shows John Smith's real time movements in the facility. Under one embodiment, the Tealpass platform computes John Smith's real time location using triangulation among BLE access points, TealpassGates or CloudGates. FIG. 10 indicates that John Smith has used exercise machines 1016, 1017, and 1018.

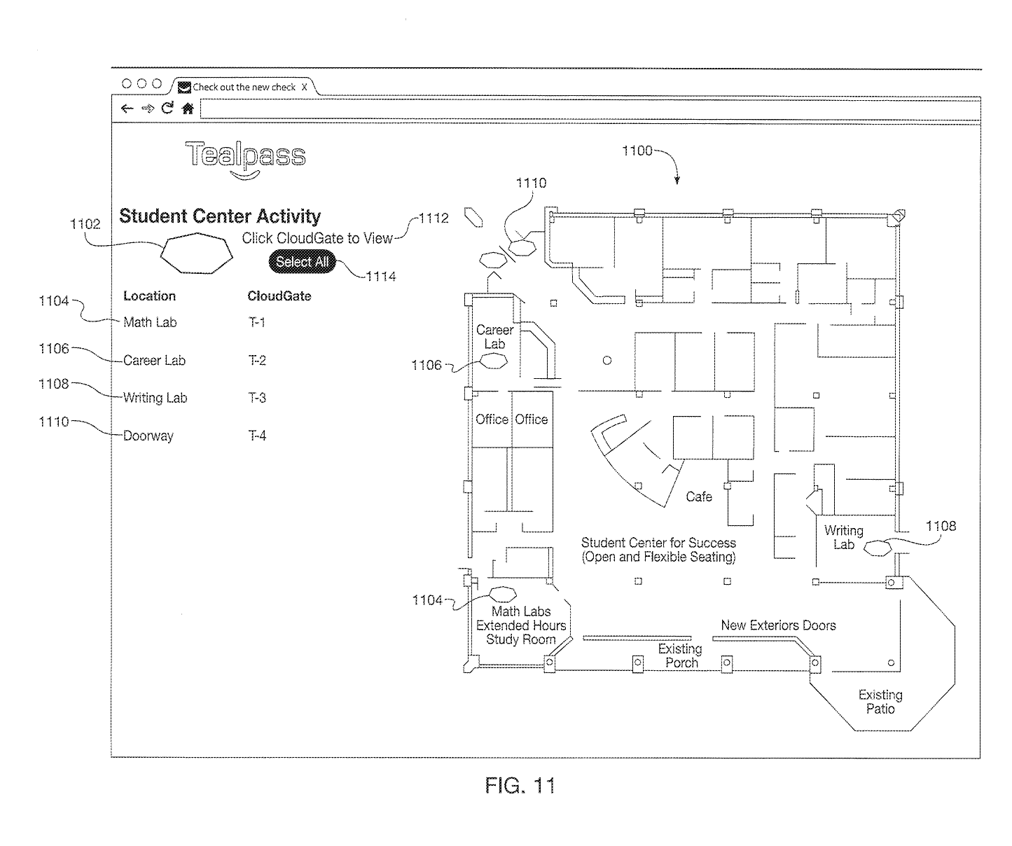

FIG. 11 shows an academic facility map screen 1100 showing the location of CloudGates. The top left of FIG. 11 shows a legend featuring a heptagon 1102 indicating a CloudGate. The top left of FIG. 11 indicates the location of CloudGates in the Math Lab 1104 (CloudGate T-1), Career Lab 1106 (CloudGate T-2), Writing Lab 1108 (CloudGate T-3), and Doorway 1110 (CloudGate T-4). The facility map screen 1100 shows the corresponding physical locations 1104, 1106, 1108, and 1110 of the CloudGates. A user may click individual CloudGates 1112 to obtain data regarding activity in its proximity. A user may also select all 1114 to obtain activity data with respect to all CloudGates.

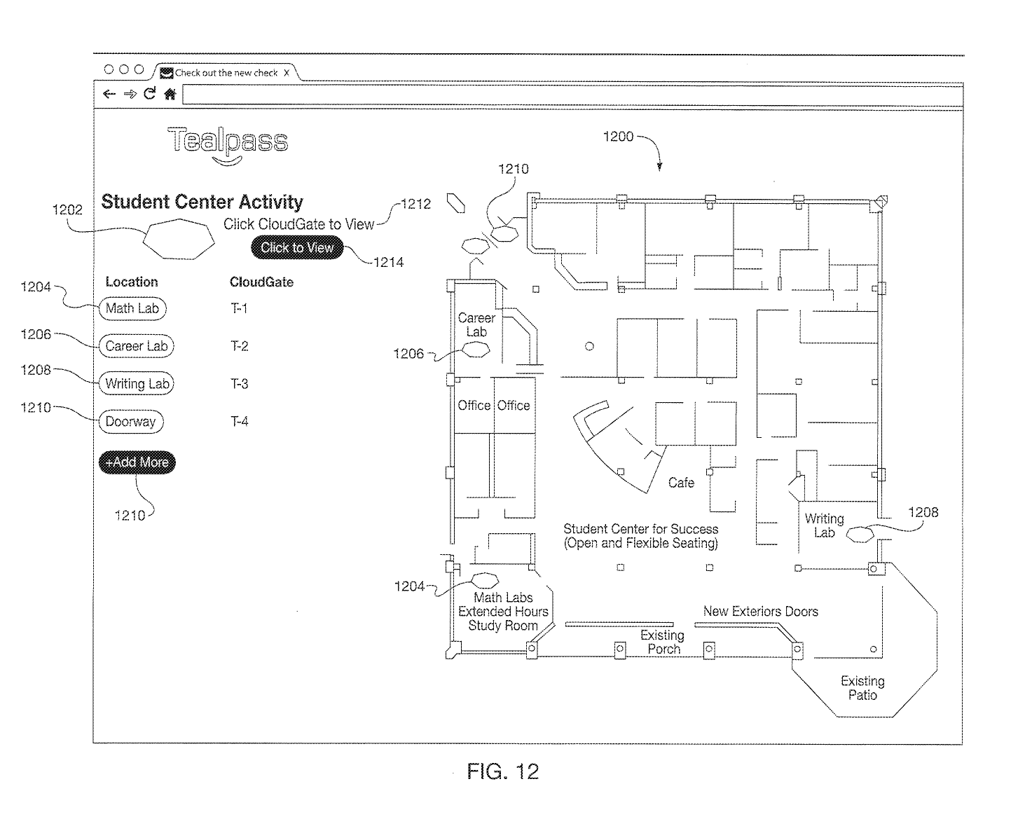

FIG. 12 again shows an academic facility map screen 1200 showing the location of CloudGates. The top left of FIG. 12 shows a legend featuring a heptagon 1202 indicating a CloudGate. The top left of FIG. 12 indicates the location of CloudGates in the Math Lab 1204 (CloudGate T-1), Career Lab 1206 (CloudGate T-2), Writing Lab 1208 (CloudGate T-3), and Doorway 1210 (CloudGate T-4). The facility map screen 1200 shows the corresponding physical locations 1204, 1206, 1208, and 1210 of the CloudGates. A user may click individual CloudGates 1212 to obtain data regarding activity in its proximity. A user may also select all 1214 to obtain activity data with respect to all CloudGates. FIG. 12 shows an additional add more 1220 button. The user may select the add more button 1220 to register additional CloudGates with the Tealpass platform.

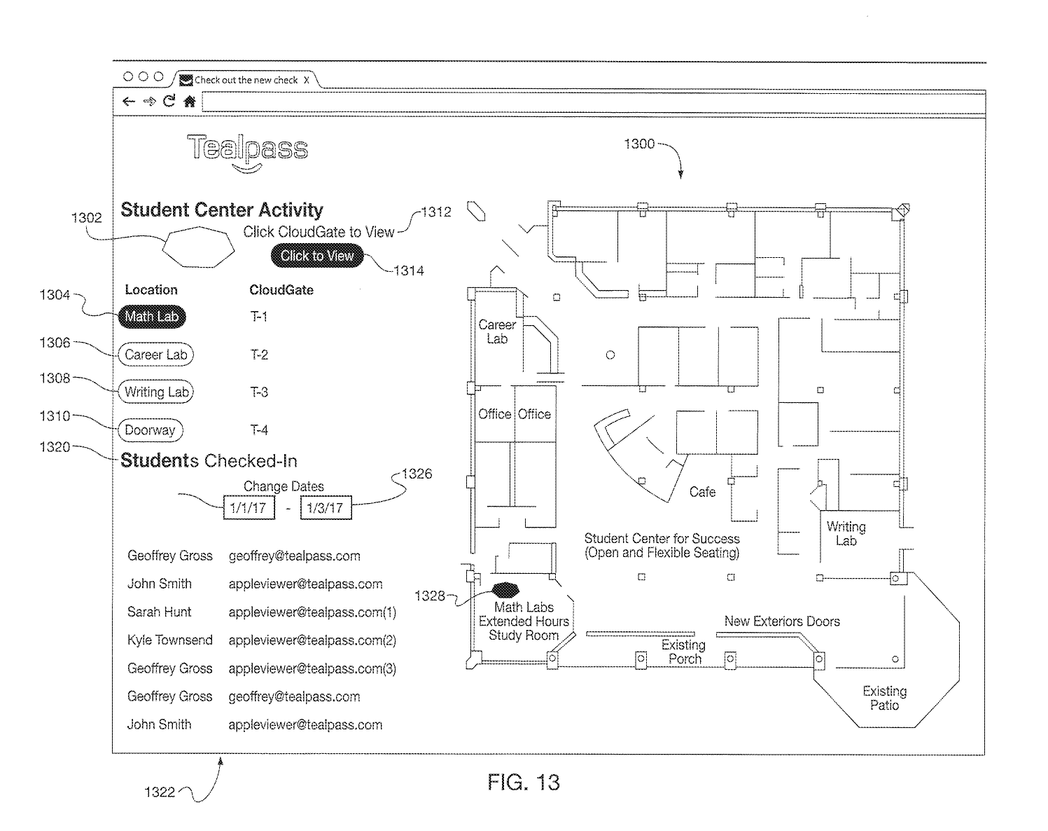

FIG. 13 again shows an academic facility map screen 1300 showing the location of CloudGates. The top left of FIG. 13 shows a map legend featuring a heptagon 1302 indicating a CloudGate. The top left of FIG. 13 indicates the location of CloudGates in the Math Lab 1304 (CloudGate T-1), Career Lab 1306 (CloudGate T-2), Writing Lab 1308 (CloudGate T-3), and Doorway 1310 (CloudGate T-4). A user may click individual CloudGates 1312 to obtain data regarding activity in its proximity. A user may also select all 1314 to obtain activity data with respect to all CloudGates. Note that a user has selected the Math Lab 1304. The bottom left of FIG. 13 displays a column entitled Students Checked-In 1320. The column displays of list of students 1322 that have checked in between selected change dates 1324, 1326. Although change dates 1324, 1326 in the figure range from Jan. 1, 2017 to Jan. 3, 2017, different change dates may be selected. The highlighted heptagon 1328 on the map indicates that the Math Lab CloudGate is selected.

A traditional ID card may typically emit RFID signals. However, the systems and methods described herein for creating an electronic pass replace the traditional ID card with a smartphone emitting BLE instead.

As described herein, the Tealpass application may be asleep in the smartphone (not closed, but not currently displayed). The application will still turn the phone into an ID card, i.e. an electronic pass as described above, even without the screen turned on.

Under one embodiment, a student (with a Tealpass mobile application or SDK in the student's smartphone) walks into a classroom, and by walking into the room, is automatically registered as being present or checked in. The smartphone UDID is continuously tracked while the smartphone is moving throughout the room. It even checks the individual out, upon leaving the room. The same student can use the platform for checking into a required seminar, convocation, or chapel. The student walks into the seminar, convocation, or chapel, and is marked as being checked in upon walking into the room. They are tracked to see how long they stayed, and when they left. Upon the class, seminar, convocation, or chapel ending, the student is optionally presented with a notification over BLE, saying that they were marked present. In some cases, the student is presented with a button, asking the student to press it in order to be marked as present.

A member of a facility requiring ID cards walks up to manage a building. As the member approaches, the member may leave a smartphone in a pocket/purse and walk past a BLE access point. The access point unlocks a door, or checks the member into the facility. The member's smartphone is tracked as it roams around the building. Under an alternative embodiment, the member takes waives the smartphone next to a BLE access point (very similar to waiving a ID card or Key Fob next to a scanner). The member walks into the managed facility, and the smartphone is tracked as it roams around the facility.

BLE Attendance Checking

BLE access points (iBeacons, raspberry pi's, mobile devices, etc), are constantly searching for BLE ID's or tickets. Upon seeing one, they mark the ID/ticket is present, over BLE, and then trigger the BLE in the ID/ticket to stop presenting.

BLE Large Scale Attendance

Under an embodiment, individuals enter a facility (arena, classroom, venue, etc). Upon sitting down, individuals open up a Tealpass application on their respective smartphones and press a button saying “Register my Attendance”, or any other text display soliciting attendance confirmation. When an individual presses that button in the application, the individual is then telling the smartphone device to start advertising BLE. The smartphone communicates with nearby BLE access points, and when the BLE passes the ticket over to Tealpass backend servers, the BLE access points informs the individual's smartphone to stop emitting BLE. It also tells the individual's smart phone if the interaction was successful or unsuccessful (valid ticket or invalid ticket).

Under an embodiment, 4,000 students enter an arena. While taking their seats, they open the Tealpass application, and press a button saying “Register My Attendance” or any other text display soliciting attendance confirmation. After pressing the button, their respective smartphones start advertising their BLE ID, and once registered with a BLE access point, a message is sent to their phone over BLE saying that individuals, i.e., smartphones, have either been marked present (valid ID), or not present (invalid ID).

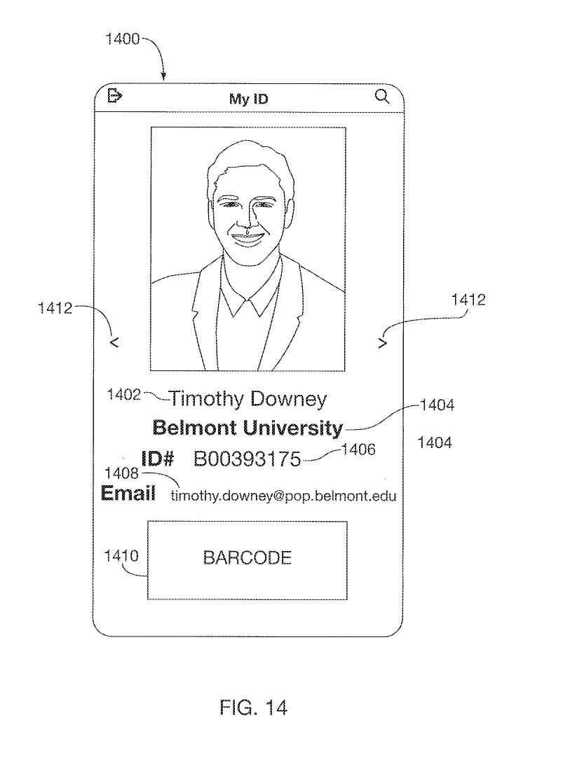

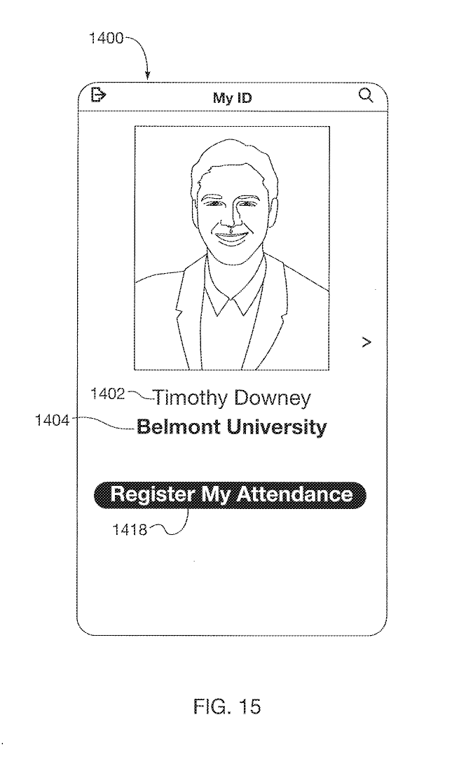

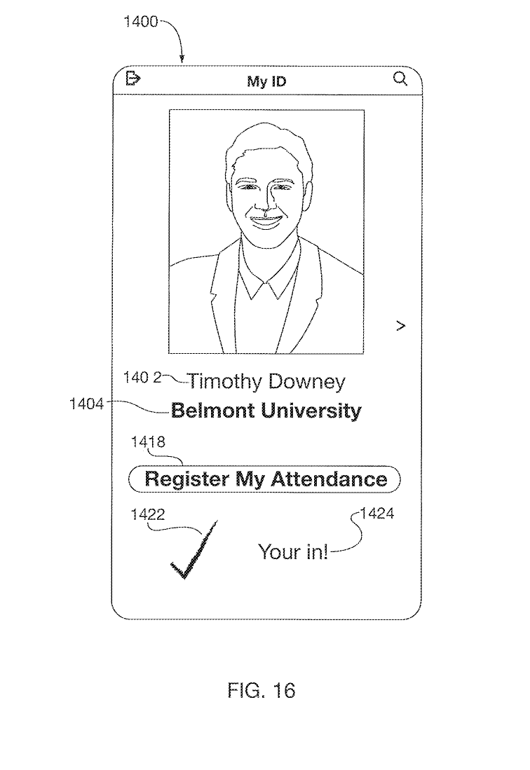

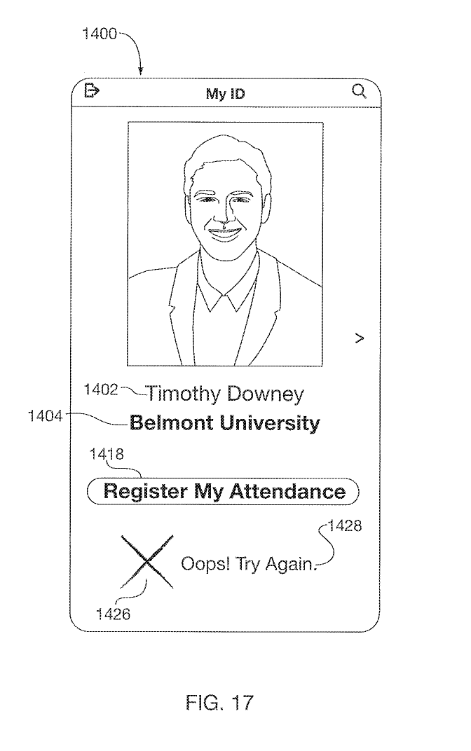

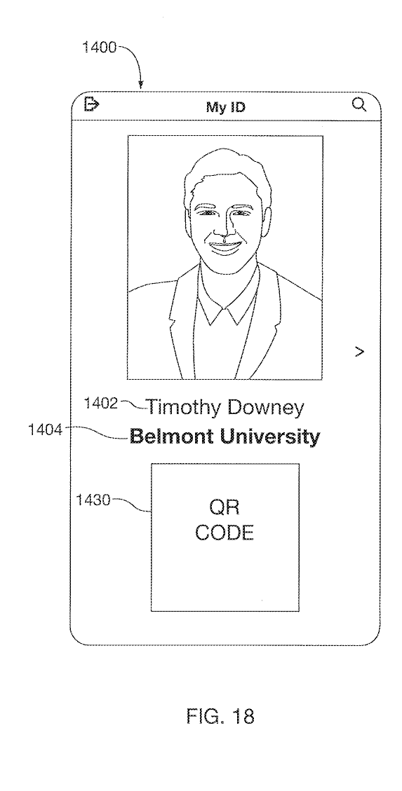

Each student may register attendance using an electronic id card created by the Tealpass application. FIG. 14 shows a smartphone screen displaying an electronic student id card 1400 generated by the Tealpass application. The student id features student name 1402, university name 1404, id number 1406, email address 1408, and a bar code 1410. The electronic id provides a swipe left 1412 or swipe right feature 1414. The swipe left gesture transitions to a student id (FIG. 15) listing student name 1402, university name 1404 and a register attendance 1418 button. The register attendance button is used when students want to mark themselves present at an event. When pressed, the phone begins emitting BLE. Once the smartphone is registered by a BLE access point, TealpassGate, or CloudGate (using the systems and methods described above), the BLE stops emitting. The student id (FIG. 16) then displays a check mark 1422 along with the message “You're in!” 1424. In this manner, 4,000 students enter an arena and all check themselves in within seconds of each other. In the event that a student check-in fails, the student id (FIG. 17) then displays an “X” mark 1426 along with the message “Oops! Try Again” 1428. With reference to the home id screen shown in FIG. 14, the swipe right 1414 gesture transitions to a simple a simple QR code page (FIG. 18). The QR code 1430 is capable of working with existing ID Card scanners.

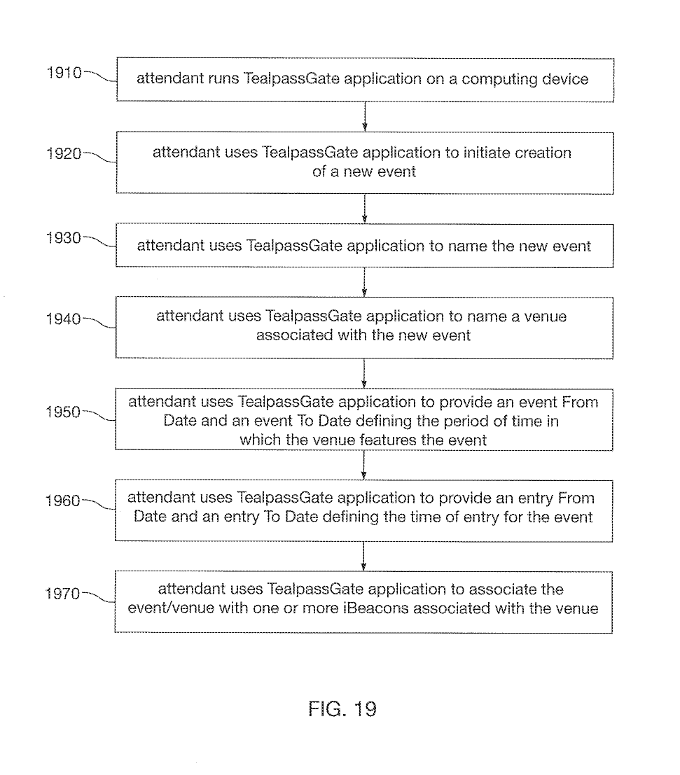

FIG. 19 shows a method for creating an event using the Tealpass platform, under an embodiment. Step 1910 includes attendant running TealpassGate application on a computing device. Step 1920 includes attendant using TealpassGate application to initiate creation of a new event. Step 1930 includes attendant using TealpassGate application to name the new event. Step 1940 includes attendant using TealpassGate application to name a venue associated with the new event. Step 1950 includes attendant using TealpassGate application to provide an event From Date and an event To Date defining the period of time in which the venue features the event. Step 1960 includes attendant using TealpassGate application to provide an entry From Date and an entry To Date defining the time of entry for the event. Step 1970 includes attendant using TealpassGate application to associate the event/venue with one or more iBeacons associated with the venue.

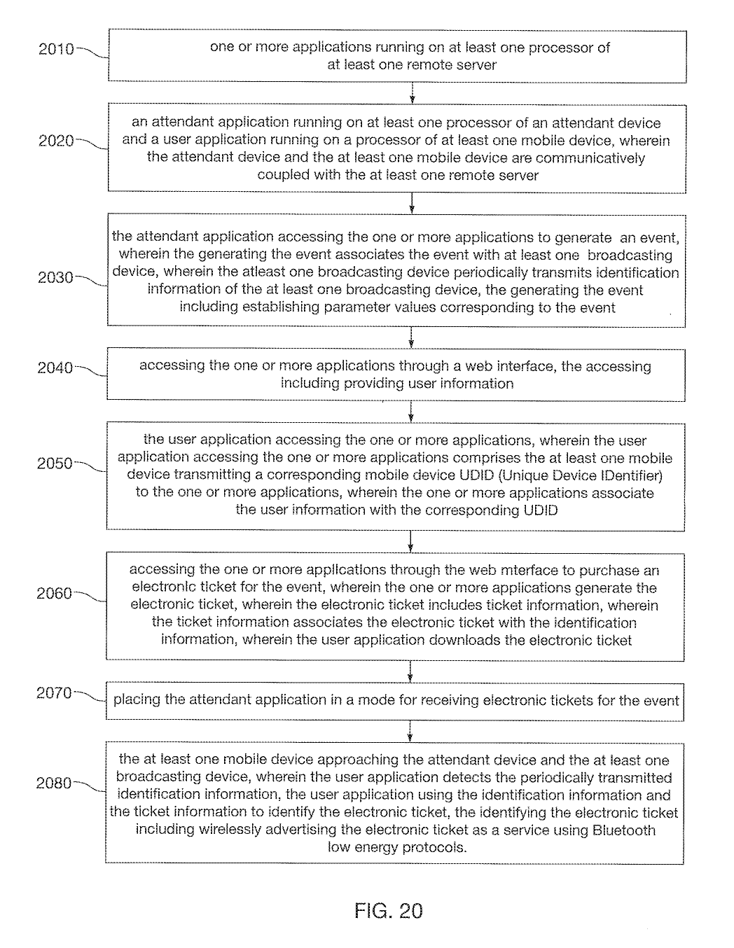

FIG. 20 shows a system for creating and delivery electronic tickets, under an embodiment. The system includes 2010 one or more applications running on at least one processor of at least one remote server. The system includes 2020 an attendant application running on at least one processor of an attendant device and a user application running on a processor of at least one mobile device, wherein the attendant device and the at least one mobile device are communicatively coupled with the at least one remote server. The system includes 2030 the attendant application accessing the one or more applications to generate an event, wherein the generating the event associates the event with at least one broadcasting device, wherein the at least one broadcasting device periodically transmits identification information of the at least one broadcasting device, the generating the event including establishing parameter values corresponding to the event. The system includes 2040 accessing the one or more applications through a web interface, the accessing including providing user information. The system includes 2050 the user application accessing the one or more applications, wherein the user application accessing the one or more applications comprises the at least one mobile device transmitting a corresponding mobile device UDID (Unique Device IDentifier) to the one or more applications, wherein the one or more applications associate the user information with the corresponding UDID. The system includes 2060 accessing the one or more applications through the web interface to purchase an electronic ticket for the event, wherein the one or more applications generate the electronic ticket, wherein the electronic ticket includes ticket information, wherein the ticket information associates the electronic ticket with the identification information, wherein the user application downloads the electronic ticket. The system includes 2070 placing the attendant application in a mode for receiving electronic tickets for the event. The system includes 2080 the at least one mobile device approaching the attendant device and the at least one broadcasting device, wherein the user application detects the periodically transmitted identification information, the user application using the identification information and the ticket information to identify the electronic ticket, the identifying the electronic ticket including wirelessly advertising the electronic ticket as a service using Bluetooth low energy protocols.

A system is described herein that comprises under an embodiment one or more applications running on at least one processor of at least one remote server, an attendant application running on at least one processor of an attendant device and a user application running on a processor of at least one mobile device, wherein the attendant device and the at least one mobile device are communicatively coupled with the at least one remote server. The system comprises the attendant application accessing the one or more applications to generate an event, wherein the generating the event associates the event with at least one broadcasting device, wherein the at least one broadcasting device periodically transmits identification information of the at least one broadcasting device, the generating the event including establishing parameter values corresponding to the event. The system comprises accessing the one or more applications through a web interface, the accessing including providing user information. The system comprises the user application accessing the one or more applications, wherein the user application accessing the one or more applications comprises the at least one mobile device transmitting a corresponding mobile device UDID (Unique Device IDentifier) to the one or more applications, wherein the one or more applications associate the user information with the corresponding UDID. The system comprises the at least one mobile device approaching the attendant device and the at least one broadcasting device, wherein the user application detects the periodically transmitted identification information.

The system of an embodiment includes and attendant device and at least one broadcasting device that are in a physical proximity to the event.

The at least one broadcasting of an embodiment device comprises one or more iBeacons.

The at least one broadcasting device of an embodiment comprises the attendant device.

The parameter values of an embodiment comprise a venue corresponding to the event.

The parameter values of an embodiment comprise a date range of the event.

The parameter values of an embodiment comprise a time period for entry to the event.

The accessing the one or more applications through the web interface include purchasing an electronic ticket for the event under an embodiment.

The one or more applications of an embodiment generate the electronic ticket, wherein the electronic ticket comprises a unique ticket identification number.

The electronic ticket of an embodiment comprises associated ticket information, wherein the associated ticket information associates the UDID, the unique ticket identification number, the event, and the identification information.

The one or more applications of an embodiment transmit a push notification to the user application, wherein the push notification comprises a notification of the electronic ticket available for download.

The user application of an embodiment downloads the electronic ticket.

An embodiment of the systems and methods described herein place the attendant application in a mode for receiving electronic tickets for the event with respect to a venue.

The user application of an embodiment uses the identification information and the associated ticket information to identify the electronic ticket, the identifying the electronic ticket including wirelessly advertising the electronic ticket.

The user application and the attendant application communicate using a wireless communications protocol under an embodiment.

The wireless communications protocol comprises a Bluetooth low energy protocol under an embodiment.

The identifying the electronic ticket includes under an embodiment wirelessly advertising the electronic ticket as a service using Bluetooth low energy protocols.

The attendant application of an embodiment requests and receives the electronic ticket from the user application.

The attendant application of an embodiment validates the electronic ticket using the event parameter values and the associated ticket information.

The validating of an embodiment includes the attendant application downloading the event parameters for local validation of the electronic ticket.

The validating of an embodiment includes communicating with the one or more applications to validate the electronic ticket.

The validating the electronic ticket includes under an embodiment transmitting the unique ticket identification number to the one or more applications.

The one or more applications of an embodiment assigns the unique ticket identification number a cancelation status in at least one database stored on the at least one remote server.

The one or more applications of an embodiment push the cancellation status to the user application of the at least one mobile device.

The attendant device of an embodiment includes at least one of a personal computer, tablet, smartphone and mobile computing device.

The at least one mobile device of an embodiment includes at least one of a personal computer, tablet, smartphone and mobile computing device.

A system is described herein that comprises one or more applications running on at least one processor of at least one remote server, an attendant application running on at least one processor of an attendant device and a user application running on a processor of at least one mobile device, wherein the attendant device and the at least one mobile device are communicatively coupled with the at least one remote server. The system includes the attendant application accessing the one or more applications to generate an event, wherein the generating the event associates the event with at least one broadcasting device, wherein the at least one broadcasting device periodically transmits identification information of the at least one broadcasting device, the generating the event including establishing parameter values corresponding to the event. The system includes accessing the one or more applications through a web interface, the accessing including providing user information. The system includes the user application accessing the one or more applications, wherein the user application accessing the one or more applications comprises the at least one mobile device transmitting a corresponding mobile device UDID (Unique Device IDentifier) to the one or more applications, wherein the one or more applications associate the user information with the corresponding UDID. The system includes accessing the one or more applications through the web interface to purchase an electronic ticket for the event, wherein the one or more applications generate the electronic ticket, wherein the electronic ticket includes ticket information, wherein the ticket information associates the electronic ticket with the identification information, wherein the user application downloads the electronic ticket. The system includes placing the attendant application in a mode for receiving electronic tickets for the event. The system includes the at least one mobile device approaching the attendant device and the at least one broadcasting device, wherein the user application detects the periodically transmitted identification information, the user application using the identification information and the ticket information to identify the electronic ticket, the identifying the electronic ticket including wirelessly advertising the electronic ticket as a service using Bluetooth low energy protocols.

Computer networks suitable for use with the embodiments described herein include local area networks (LAN), wide area networks (WAN), Internet, or other connection services and network variations such as the world wide web, the public internet, a private internet, a private computer network, a public network, a mobile network, a cellular network, a value-added network, and the like. Computing devices coupled or connected to the network may be any microprocessor controlled device that permits access to the network, including terminal devices, such as personal computers, workstations, servers, mini computers, main-frame computers, laptop computers, mobile computers, palm top computers, hand held computers, mobile phones, TV set-top boxes, or combinations thereof. The computer network may include one of more LANs, WANs, Internets, and computers. The computers may serve as servers, clients, or a combination thereof.

The Tealpass platform can be a component of a single system, multiple systems, and/or geographically separate systems. The Tealpass platform can also be a subcomponent or subsystem of a single system, multiple systems, and/or geographically separate systems. The Tealpass platform components can be coupled to one or more other components (not shown) of a host system or a system coupled to the host system.

One or more components of the Tealpass platform and/or a corresponding interface, system or application to which the Tealpass platform is coupled or connected includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components, and/or provided by some combination of algorithms. The methods described herein can be implemented in one or more of software algorithm(s), programs, firmware, hardware, components, circuitry, in any combination.

The components of any system that include the Tealpass platform can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the Tealpass platform and corresponding systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the Tealpass platform and corresponding systems and methods include: microcontrollers with memory (such as electronically erasable programmable read only memory (EEPROM)), embedded microprocessors, firmware, software, etc. Furthermore, aspects of the Tealpass platform and corresponding systems and methods may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the Tealpass platform and corresponding systems and methods is not intended to be exhaustive or to limit the systems and methods to the precise forms disclosed. While specific embodiments of, and examples for, the Tealpass platform and corresponding systems and methods are described herein for illustrative purposes, various equivalent modifications are possible within the scope of the systems and methods, as those skilled in the relevant art will recognize. The teachings of the Tealpass platform and corresponding systems and methods provided herein can be applied to other systems and methods, not only for the systems and methods described above.

The elements and acts of the various embodiments described above can be combined to provide further embodiments. These and other changes can be made to the Tealpass platform and corresponding systems and methods in light of the above detailed description.

We claim:

1. A system comprising,
one or more applications running on at least one processor of at least one remote server;
an attendant application running on at least one processor of an attendant device and a user application running on a processor of at least one mobile device, wherein the attendant device and the at least one mobile device are communicatively coupled with the at least one remote server;
the attendant application accessing the one or more applications to generate an event, wherein the generating the event associates the event with at least one broadcasting device, wherein the at least one broadcasting device periodically transmits identification information of the at least one broadcasting device, the generating the event including establishing parameter values corresponding to the event;
accessing the one or more applications through a web interface, the accessing including providing user information;
the user application accessing the one or more applications, wherein the user application accessing the one or more applications comprises the at least one mobile device transmitting a corresponding mobile device UDID (Unique Device IDentifier) to the one or more applications, wherein the one or more applications associate the user information with the corresponding UDID;
the at least one mobile device approaching the attendant device and the at least one broadcasting device, wherein the user application detects the periodically transmitted identification information.

2. The system of claim 1, wherein the attendant device and at least one broadcasting device are in a physical proximity to the event.

3. The system of claim 1, wherein the at least one broadcasting device comprises one or more iBeacons.

4. The system of claim 1, wherein the at least one broadcasting device comprises the attendant device.

5. The system of claim 1, the parameter values comprising a venue corresponding to the event.

6. The system of claim 1, the parameter values comprising a date range of the event.

7. The system of claim 1, the parameter values comprising a time period for entry to the event.

8. The system of claim 1, the accessing the one or more applications through the web interface including purchasing an electronic ticket for the event.

9. The system of claim 8, wherein the one or more applications generate the electronic ticket, wherein the electronic ticket comprises a unique ticket identification number.

10. The system of claim 9, wherein the electronic ticket comprises associated ticket information, wherein the associated ticket information associates the UDID, the unique ticket identification number, the event, and the identification information.

11. The system of claim 10, the one or more applications transmitting a push notification to the user application, wherein the push notification comprises a notification of the electronic ticket available for download.

12. The system of claim 11, the user application downloading the electronic ticket.

13. The system of claim 12, placing the attendant application in a mode for receiving electronic tickets for the event with respect to a venue.

14. The system of claim 13, the user application using the identification information and the associated ticket information to identify the electronic ticket, the identifying the electronic ticket including wirelessly advertising the electronic ticket.

15. The system of claim 14, wherein the user application and the attendant application communicate using a wireless communications protocol.

16. The system of claim 15, wherein the wireless communications protocol comprises a Bluetooth low energy protocol.

17. The system of claim 16, the identifying the electronic ticket including wirelessly advertising the electronic ticket as a service using Bluetooth low energy protocols.

18. The system of claim 17, the attendant application requesting and receiving the electronic ticket from the user application.

19. The system of claim 18, the attendant application validating the electronic ticket using the event parameter values and the associated ticket information.

20. The system of claim 19, the validating including the attendant application downloading the event parameters for local validation of the electronic ticket.

21. The system of claim 19, the validating including communicating with the one or more applications to validate the electronic ticket.

22. The system of claim 19, the validating the electronic ticket including transmitting the unique ticket identification number to the one or more applications.

23. The system of claim 22, the one or more applications assigning the unique ticket identification number a cancelation status in at least one database stored on the at least one remote server.

24. The system of claim 23, the one or more applications pushing the cancellation status to the user application of the at least one mobile device.

25. The system of claim 1, wherein the attendant device includes at least one of a personal computer, tablet, smartphone and mobile computing device.

26. The system of claim 1, wherein the at least one mobile device includes at least one of a personal computer, tablet, smartphone and mobile computing device.

27. A system comprising,
one or more applications running on at least one processor of at least one remote server;
an attendant application running on at least one processor of an attendant device and a user application running on a processor of at least one mobile device, wherein the attendant device and the at least one mobile device are communicatively coupled with the at least one remote server;
the attendant application accessing the one or more applications to generate an event, wherein the generating the event associates the event with at least one broadcasting device, wherein the at least one broadcasting device periodically transmits identification information of the at least one broadcasting device, the generating the event including establishing parameter values corresponding to the event;
accessing the one or more applications through a web interface, the accessing including providing user information;
the user application accessing the one or more applications, wherein the user application accessing the one or more applications comprises the at least one mobile device transmitting a corresponding mobile device UDID (Unique Device IDentifier) to the one or more applications, wherein the one or more applications associate the user information with the corresponding UDID;
accessing the one or more applications through the web interface to purchase an electronic ticket for the event, wherein the one or more applications generate the electronic ticket, wherein the electronic ticket includes ticket information, wherein the ticket information associates the electronic ticket with the identification information, wherein the user application downloads the electronic ticket;
placing the attendant application in a mode for receiving electronic tickets for the event;
the at least one mobile device approaching the attendant device and the at least one broadcasting device, wherein the user application detects the periodically transmitted identification information, the user application using the identification information and the ticket information to identify the electronic ticket, the identifying the electronic ticket including wirelessly advertising the electronic ticket as a service using Bluetooth low energy protocols.
